(19) United States
(12) Patent Application Publication
(10) Pub. No.: US 2018/0283452 A1
(43) Pub. Date: Oct. 4, 2018

(54) Retainerless Rolling Element Bearing

(71) Applicant: City University of Hong Kong, Kowloon (HK)

(72) Inventors: Pat Lam Patrick Wong, Kowloon (HK); Yang Zhao, Xuzhou (CN); Feng Guo, Kowloon (HK); Junhong Mao, Kowloon (HK)

(73) Assignee: City University of Hong Kong

(21) Appl. No.: 15/477,377

(22) Filed: Apr. 3, 2017

(51) Int. Cl. F16C 33/32; F16C 19/06; F16C 19/26; F16C 33/34; F16C 33/66

(52) U.S. Cl. CPC F16C 33/32; F16C 19/06; F16C 33/6637; F16C 33/34; F16C 19/26

(57) ABSTRACT

A retainerless rolling element bearing (20) is disclosed as including an inner raceway (22), an outer raceway (24), a plurality of first type of rolling elements (26) and a plurality of second type of rolling elements (28) alternately arranged adjacent to each other and between the inner raceway and the outer raceway, a surface of the first type of rolling elements having a higher contact angle, a lower contact angle hysteresis and a smaller magnitude of surface energy than a surface of the second type of rolling elements.

### BACKGROUND OF THE INVENTION

A rolling element bearing basically consists of (i) inner and outer raceways, (ii) rolling elements (which may be balls or rollers), and (iii) a retainer. The function of the retainer is to space out the rolling elements. Otherwise, the rolling elements are squeezed into direct contact with and slide against one another with the same surface speed but in opposite direction (zero-entrainment-velocity, ZEV). When at the ZEV conditions, while a surface drags oil into the ZEV contact, the opponent surface which moves in the opposite direction brings the oil out. It thus leads to a serious problem of friction and wear. On the other hand, bearings without retainer (“retainerless bearings”) have great benefits, such as higher load capacity (more rolling elements used), space-saving and simpler structure. However, retainerless bearings suffer from shorter life and run only in slow speed.

It is thus an object of the present invention to provide a retainerless rolling element bearing in which the aforesaid shortcomings are mitigated or at least to provide a useful alternative to the trade and public.

### SUMMARY OF THE INVENTION

According to the present invention, there is provided a retainerless rolling element bearing including an inner raceway, an outer raceway, and at least a first type of rolling element and a second type of rolling element adjacent to each other and between the inner raceway and the outer raceway, wherein a surface of said first type of rolling element has a higher contact angle, a lower contact angle hysteresis and a smaller magnitude of surface energy than a surface of said second type of rolling element.

### BRIEF DESCRIPTION OF THE DRAWINGS

An embodiment of the present invention will now be described, by way of example only, with reference to the accompanying drawings, in which:

FIG. 1a shows elastohydrodynamic lubrication (EHL) contacts of a steel ball with an untreated surface with a glass disc with an untreated surface at ZEV conditions (speed: 100 mm/s, Pₒ: 0.46 GPa, PAO40);

FIG. 1b shows elastohydrodynamic lubrication (EHL) contacts of a steel ball with an untreated surface with a glass disc with a surface treated with oleophobic coating at ZEV conditions (speed: 100 mm/s, Pₒ: 0.46 GPa, PAO40);

FIG. 2a shows EHL contacts of a “non-slip” ball and a “slip” disc, the disc surface moving at a speed (u_{disc}) of +400 mm/s (towards the right), and the ball surface moving at a speed (u_{ball}) of −360 mm/s (towards the left);

FIG. 2b shows EHL contacts of a “non-slip” ball and a “slip” disc, the disc surface moving at a speed (u_{disc}) of +400 mm/s (towards the right), and the ball surface moving at a speed (u_{ball}) of −400 mm/s (towards the left);

FIG. 2c shows EHL contacts of a “non-slip” ball and a “slip” disc, the disc surface moving at a speed (u_{disc}) of +400 mm/s (towards the right), and the ball surface moving at a speed (u_{ball}) of −450 mm/s (towards the left);

FIG. 2d shows schematically the entrainment of oil by the non-slip surface of the ball; and

FIG. 3 shows a schematic view of a retainerless rolling element bearing according to an embodiment of the present invention.

### DETAILED DESCRIPTION OF THE EMBODIMENT

Classical elastohydrodynamic lubrication (EHL) theory describes lubricated contacts between highly stressed, non-conformal components. The film thickness decreases, theoretically, with the decrease in the entrainment velocity (average velocity of the two bounding surfaces). If one of the bounding surfaces moves with the same linear speed as the opponent surface, but in the opposite direction, which is referred to as zero-entrainment-velocity (ZEV) conditions, no hydrodynamic lubricating film should exist. The failure of lubrication at ZEV conditions leads to high friction and wear problems. The contact of two adjacent rolling elements in roller bearings operating without retainer is under ZEV conditions. Application examples of retainerless bearings can be found in wind turbines and mining machineries (high load and low speed). Generally, retainerless bearings are suitable for very heavy radial-load applications but cannot operate at high speeds as conventional bearings (with retainer) do.

It has been found that, for hydrodynamic or elastohydrodynamic lubricated contact bounded by surfaces of different surface energies, the lubricant tends to slide on the surface of lower surface energy if the criteria for the onset of boundary slippage are fulfilled. Hence, effective lubrication can be, theoretically, generated in ZEV EHL contacts based on the difference in surface energy of the two bounding surfaces.

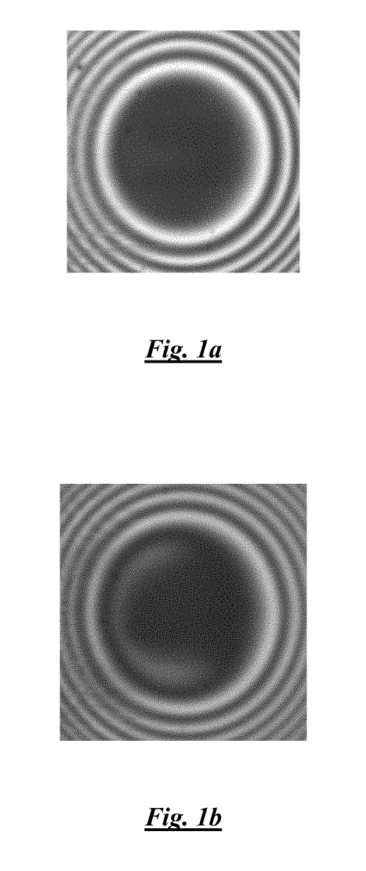

Experiments on the idea of boundary slip in ZEV EHL contacts were conducted with a steel ball and a glass disc. A control test was performed with a glass disc with an untreated surface (called an “untreated glass disc”) and a steel ball with an untreated surface (called an “untreated steel ball”) running under the following conditions: 100 mm/s, Pₒ: 0.46 GPa. The film shape of the ZEV contacts of the control test is shown in FIG. 1a, which shows that no hydrodynamic film was formed at the ZEV conditions. The test was then carried out under the same conditions (namely, 100 mm/s, Pₒ: 0.46 GPa), with the only exception being that the glass disc surface was treated with an oleophobic coating. The film shape of the ZEV contacts of this test is shown in FIG. 1b. A classic horseshoe film shape was observed in the ZEV test using the oleophobic glass disc, showing that a full lubricating film was formed by the EHL effect.

In the test, the glass disc was treated, by being coated, with a thin layer of oleophobic material, e.g. Aculon, which is a commercial product for glass screen protection traded by Aculon Inc., of San Diego, USA. Aculon is an optically transparent coating and is indicated as being highly hydrophobic and oleophobic. The lubricant used was PAO40, which is a high viscosity polyalphaolefin (PAO) fluid, manufactured by the polymerization of alphaolefins. PAO40 has excellent oxidation resistance, shear stability, lower pour point, low volatility and a high flash point. It can be used as a base stock and viscosity builder for a wide range of engine and industrial lubricating oil products. The surface of Aculon was characterized with PAO40 and was found to have a fairly large contact angle (CA) and a rather small contact angle hysteresis (CAH), which indicated that the surface of the glass disc is more oleophobic than the opponent steel ball surface. Thus, PAO40 is most possibly able to slide on the Aculon-treated surface but not on the untreated glass or the untreated steel surface (both glass and steel exhibiting similar CA and CAH values). Hence, the PAO40-lubricated conjunction of Aculon and steel surface was used in the verification experiments, in which the test using the oleophobic glass disc was repeated with increased load and speed.

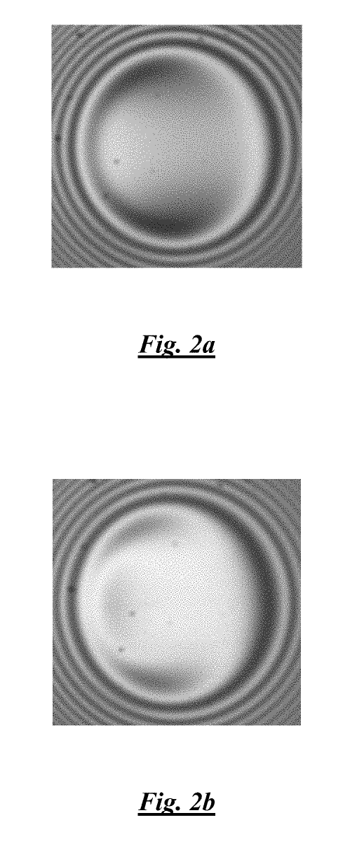

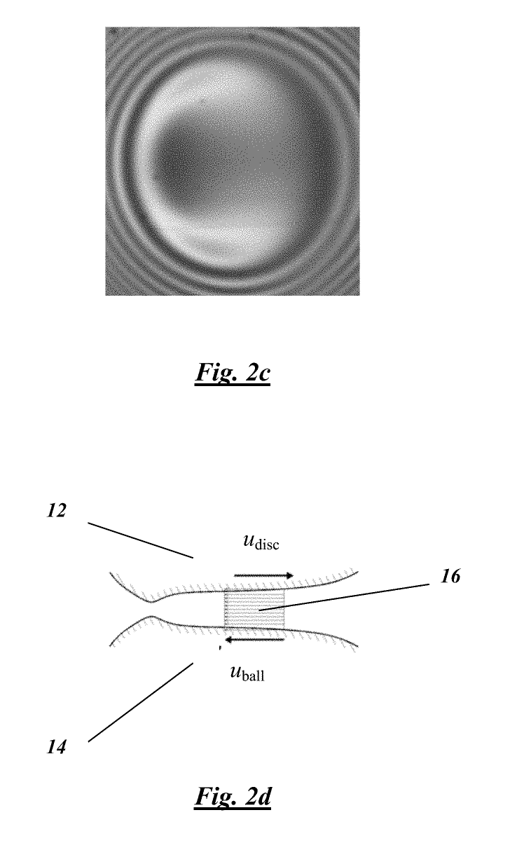

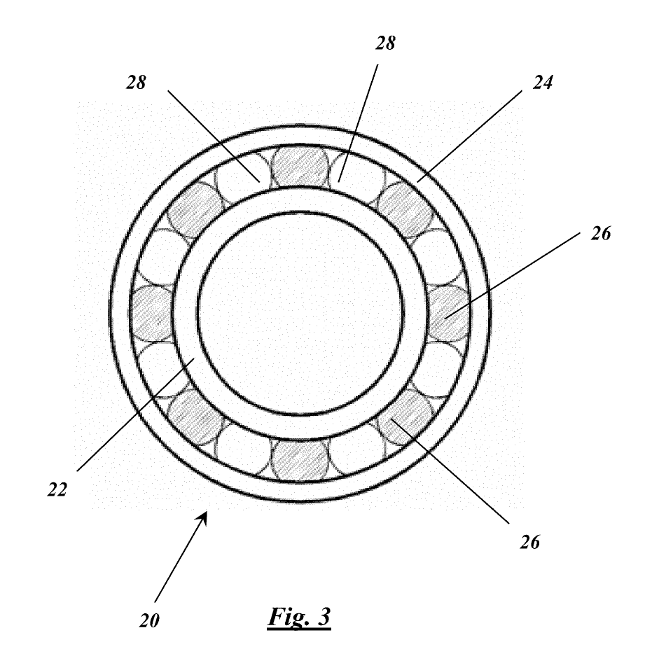

FIGS. 2a to 2c show images captured in the verification experiments with different slide-to-roll ratios with the speed of the treated glass disc being kept constant at 400 mm/s to the right in each case, and the maximum contact pressure, Pₒ, being 0.7 GPa. In each of the experiments, the treated glass disc moves to the right at a speed of 400 mm/s.

FIG. 2a shows an image captured in the verification experiment in which the steel ball surface moves towards the left at a speed of 360 mm/s. FIG. 2b shows an image captured in the verification experiment in which the steel ball surface moves towards the left at a speed of 400 mm/s, thus at a ZEV condition. A clear horseshoe-shaped EHL film at the ZEV condition is established. FIG. 2c shows an image captured in the verification experiment in which the steel ball surface moves towards the left at a speed of 450 mm/s. In all these verification experiments, effective entrainment of oil (lubricant) by the ball surface was evident. Different film thickness were due to different sliding speed (Δ|u_{ball}−u_{disc}|). The thickness of the central film in the image of FIG. 2b is approximately 0.3 μm, which demonstrates successful entrainment of the lubricant oil through the contact, forming an effective EHL film. The film shape of the ZEV contacts with the oleophobic surface (as shown in FIG. 2b) is very much like the classical EHL film.

FIG. 2d shows schematically the entrainment of an oil lubricant 16 by a non-slip surface of a steel ball 14 against a slip surface of a glass disc 12, in which the surface of the glass disc 12 moves to the right at a speed of u_{disc} and the surface of the steel ball 14 moves to the left at a speed of u_{ball}, in which u_{disc} and u_{ball} are equal in magnitude but opposite in direction. The terms “slip” and “non-slip” are in a relative sense, just as the terms “non-wetted” and “wetted” and the terms “oleophobic” and “oleophilic” are also respectively in a relative sense. Put simply, the oleophoblic (“slip” or “non-wetted”) surface has a higher CA, a lower CAH and a smaller magnitude of surface energy than the oleophilic (“non-slip” or “wetted”) surface.

A retainerless rolling element bearing according to an embodiment of the present invention is shown in FIG. 3, and generally designated as 20. The bearing 20 has an inner raceway 22 and an outer raceway 24, with a number of rolling elements 26, 28 therebetween. The rolling elements 26, 28 may be of a spherical or cylindrical shape, and are closely adjacent each other. The surfaces of the rolling elements 26 are oleophobic and the surfaces of the rolling elements 28 are oleophilic. For example, while the surfaces of the rolling elements 26 are made of or treated, e.g. by being coated, with a thin layer of oleophobic material, such as Aculon, the surfaces of the rolling elements 28 are untreated. It can be seen that the rolling elements 26, 28 are alternately arranged, meaning that each of the rolling elements 26 is between two closely adjacent rolling elements 28, and each of the rolling elements 28 is between two closely adjacent rolling elements 26.

A lubricant is provided between the inner raceway 22 and the outer raceway 24 and amongst the rolling elements 26, 28. The lubricant is an oil or an oil with an additive to provide desired surface properties for the rolling elements 26, 28.

The retainerless rolling element bearing 20 according to the present invention, while removing the retainer, does not compromise on the applied speed range. It also enables high radial-load capacity with full pack of rolling elements and the maximum rotational speed as that of conventional rolling element bearings with retainers. Such a design is stronger, simpler, space-saving and cost-saving.

It should be understood that the above only illustrates an example whereby the present invention may be carried out, and that various modifications and/or alterations may be made thereto without departing from the spirit of the invention. It should also be understood that various features of the invention which are, for brevity, described in the context of a single embodiment, may also be provided separately or in any appropriate sub-combinations.

1. A retainerless rolling element bearing including:
an inner raceway,
an outer raceway, and
at least a first type of rolling element and a second type of rolling element adjacent to each other and between the inner raceway and the outer raceway,
wherein a surface of said first type of rolling element has a higher contact angle, a lower contact angle hysteresis and a smaller magnitude of surface energy than a surface of said second type of rolling element.

2. A retainerless rolling element bearing according to claim 1, further including a plurality of said first type of rolling elements and a plurality of said second type of rolling elements.

3. A retainerless rolling element bearing according to claim 2, wherein said plurality of said first type of rolling elements and said plurality of said second type of rolling elements are alternately arranged.

4. A retainerless rolling element bearing according to claim 1, wherein said first type of rolling element is treated with an oleophobic material or made of an oleophobic material.

5. A retainerless rolling element bearing according to claim 1, wherein said first type of rolling element and said second type of rolling element are of a spherical or cylindrical shape.

6. A retainerless rolling element bearing according to claim 1, further including a lubricant between said inner raceway and said outer raceway.

7. A retainerless rolling element bearing according to claim 6, wherein said lubricant comprises at least partly of an oil.
